(19) United States
(12) Patent Application Publication
(10) Pub. No.: US 2012/0176331 A1
(43) Pub. Date: Jul. 12, 2012

(54) ROTATION DETECTION DEVICE AND MOBILE TERMINAL PROVIDED WITH SAME

(75) Inventor: Masatoshi Nakao, Kanagawa (JP)

(73) Assignee: PANASONIC CORPORATION, Osaka (JP)

(21) Appl. No.: 13/394,767

(22) PCT Filed: Sep. 28, 2010
(86) PCT No.: PCT/JP2010/005836

§ 371 Date: Mar. 7, 2012

(30) Foreign Application Priority Data
Sep. 30, 2009 (JP) 2009-228280

(51) Int. Cl. G06F 3/041

(52) U.S. Cl. 345/173

(57) ABSTRACT

A rotation detection device includes a guide portion configured to guide a finger touch position, one or more sensing elements configured to detect a finger touch, and a determination unit configured to determine the rotational operation of the finger based on a detection result of the one or more sensing elements. At least a part of the one or more sensing elements is situated closer to an outside of the rotation detection device than the guide portion.

### TECHNICAL FIELD

The present invention relates to a rotation detection device and a mobile terminal provided with the same.

### BACKGROUND ART

As a first related-art example, Patent Document 1 describes a rotation detection device not provided with a mechanical rotation mechanism. The rotation detection device detects motions of a user's finger on the device by way of a sensor and converts the finger's motions detected by the sensor into motions for focusing on an item displayed on a graphical user interface.

As a second related-art example, in a mobile terminal described in Patent Document 2, a rotation detection device is provided with a mechanical rotation mechanism. For this reason, when compared with mobile device provided with a rotation detection device not having a mechanical mechanism, the mobile terminal described in Patent Document 1 inevitably is large-sized in its thickness direction.

### RELATED ART DOCUMENTS

### Patent Documents

Patent Document 1: JP-A-2005-507112

Patent Document 2: JP-A-2003-296006

### SUMMARY OF THE INVENTION

### Problem to be Solved by the Invention

However, since it is too large for applying the rotation detection device described in Patent Document 1 to a mobile terminal, such as a cellular phone, if the rotation detection device is applied as it is, the mobile terminal will become greater in size. Further, even when the size of the rotation detection device described in Patent Document 1 is simply reduced and applied to a mobile terminal, such as a cellular phone, the user's finger greatly goes out of a sensing range of the rotation detection device. Consequently, motions of the user's finger cannot be detected. Moreover, the rotation detection device provided with a mechanical rotation mechanism described in Patent Document 2 inevitably large sized in its thickness direction when compared with a mobile device including a rotation detection device not provided with a mechanical mechanism.

An object of the present invention is to provide a rotation detection device and a mobile terminal provided with the same, which is small-sized, and which can be controlled by rotational operation of a user's finger on the device such that the user's finger does not get out of a sensing range of a sensing element at the rotation operation.

### Means for Solving the Problem

As an embodiment of the present invention, there is provided a rotation detection device comprising: a guide portion configured to guide a touch position of a finger; one or more sensing elements configured to detect a touch of a finger; and a determination unit configured to determine rotational operation of the finger based on a detection result of the one or more sensing elements, wherein at least a part of the one or more sensing elements is situated closer to an outside of the rotation detection device than the guide portion.

In the rotation detection device, the one or more sensing elements comprise a plurality of sensing elements having different sizes.

In the rotation detection device, the one or more sensing elements comprise a first group of sensing elements arranged along an outer shape of the guide portion and a second group of sensing elements arranged closer to the outside of the rotation detection device than the guide portion.

In the rotation detection device, in addition to determining the rotational operation of the finger, the determination unit determines whether the finger belongs to a left hand or a right hand, based on the detection result of the one or more sensing elements.

In the rotation detection device, the one or more sensing elements are arranged such that a sensing range of the one or more sensing elements includes a trace defined by the rotational operation of the finger.

In the rotation detection device, at least a part of the one or more sensing elements is configured to move to a position closer to the outside of the rotating detection device than the guide portion.

As another embodiment of the invention, there is provided a mobile terminal comprising the rotation detection device.

### Advantages of the invention

According to the rotation device and the mobile terminal provided with the same, the device is small-sized, and the device can be controlled by rotational operation of the user's finger on the device such that the user's finger does not get out of a sensing range of a sensing element at the rotational operation.

### BRIEF DESCRIPTION OF THE DRAWINGS

FIG. 1 is a block diagram showing a configuration of a rotation detection device 30 of a first embodiment.

FIG. 2 is a diagram showing an example of touch levels of respective sensing elements of a touch position determination unit 36.

FIG. 3 is a diagram showing a relationship between a touch position (an angle) of a user's finger and a touch level.

FIG. 4(a) is a diagram showing a width of a touch detection device of related art required to detect a touch, and FIG. 4(b) it is a diagram showing a width of a touch detection unit 32 of the first embodiment.

FIG. 5 is a diagram showing a modification (1) of the touch detection unit 32 of the first embodiment.

FIG. 6 is a diagram showing a modification (2) of the touch detection unit 32 of the first embodiment.

FIG. 7 is a diagram showing a modification (3) of the touch detection unit 32 of the first embodiment.

FIG. 8 is a diagram showing a relationship between a touch position (an angle) and a touch level of a user's finger achieved when the touch detection unit 32 includes a single sensing element Sm.

FIG. 9 is a block diagram showing a configuration of a rotation detection device 60 of a second embodiment.

FIG. 10 is a diagram showing an extended state of a slider cellular phone 100.

FIG. 11 is a diagram showing a closed state of the slider cellular phone 100.

FIG. 12 is a diagram showing a configuration in which a part of the sensing elements move toward an outside of a sensing range of a touch detection unit 62.

FIG. 13 is a block diagram showing a configuration of a rotation detection device 80 of a third embodiment.

FIG. 14 is a diagram showing a closed state of a flip cellular phone 300.

FIG. 15 is a diagram showing a first open state of the flip cellular phone 300.

FIG. 16 is a diagram showing a second open state of the flip cellular phone 300.

FIG. 17(a) is a diagram showing positions of a plurality of sensing elements Qk, FIG. 17(b) is a diagram showing a position of a part of the sensing elements configured to move toward an outside of a sensing range of a touch detection unit 82 along its radial direction when the mobile terminal is in the first open state, and FIG. 17(c) is a diagram showing a position of a part of the sensing elements that are configured to move toward an outside of a sensing range of the touch detection unit 82 along its radial direction when the mobile terminal is in the second open state.

FIG. 18 is a diagram showing a first example of detection of other touch detection unit 306.

FIG. 19 is a diagram showing a second example of detection of other touch detection unit 306.

### MODE FOR CARRYING OUT THE INVENTION

Embodiments of the present invention are hereunder described by reference to the drawings.

### First Embodiment

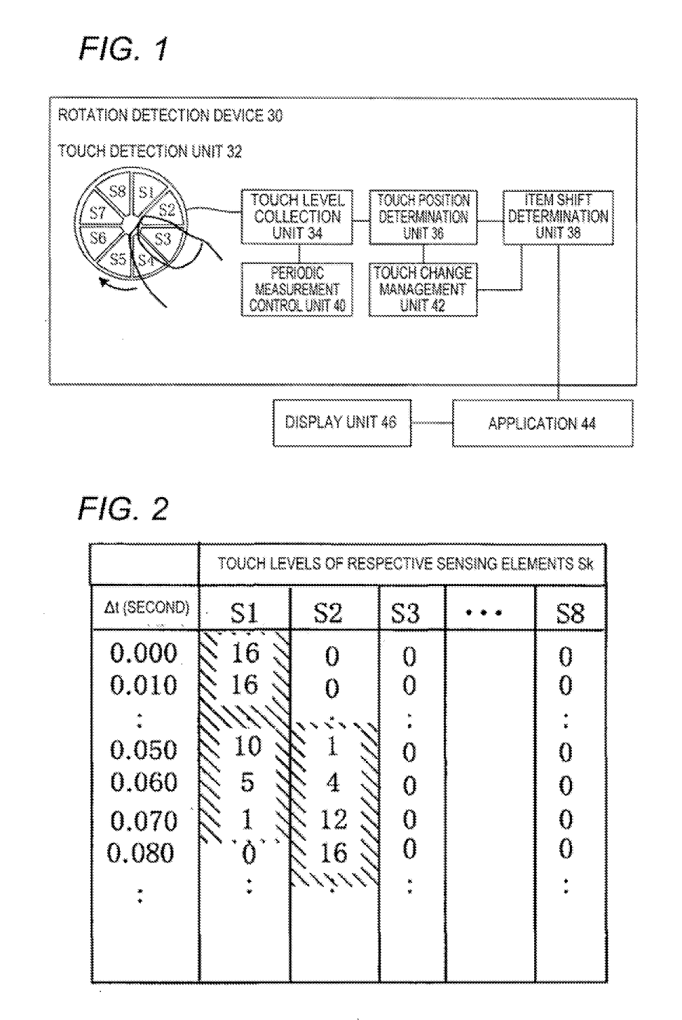

By reference to FIG. 1, a configuration of a rotation detection device 30 of a first embodiment is described. FIG. 1 is a block diagram showing the configuration of the rotation detection device 30 of the first embodiment. The rotation detection device 30 shown in FIG. 1 includes a touch detection unit 32, a touch level collection unit 34, a touch position determination unit 36, an item shift determination unit 38, and a periodic measurement control unit 40, and a touch change management unit 42. Although not shown in FIG. 1, the rotation detection device 30 includes a guide portion G. In the present embodiment, a case where a user operates the rotation detection device 30 with a right thumb (hereinafter referred to as a “user's finger”) is described.

The touch detection unit 32 includes a plurality of sensing elements Sk (k=1, . . . , n: “n” is a natural number) capable of detecting a state of touch of the user's finger. In the embodiment, “k” is eight, and the touch detection unit 32 includes eight sensing elements. An outer shape of the touch detection unit 32 is circular, and the touch detection unit 32 is circumferentially segmented at predetermined angles or intervals. The sensing element Sk is placed in each of the segments. An outer shaper of sensing element Sk is a substantially fan shape conforming to each of the segments of the touch detection unit 32. Although not shown in FIG. 1, the rotation detection device 30 includes a guide (i.e., the guide portion G for guiding a touch position of a finger) for allowing an operable region of the sensing elements Sk to be visible for the user. At least a part of the sensing elements Sk is placed so as to situate outside the guide portion G. In addition to allowing the user to visually recognize the operable region of the sensing elements Sk, the guide portion G may be configured to allow the user tactually recognize the same, to allow the user to visually and tactually recognize the same, etc.

In response to an inquiry from the touch level collection unit 34 described later, the touch detection unit 32 outputs, to the touch level collection unit 34, a numeral (hereinafter called a “touch level”) according to a degree of touch of a user's finger detected by each of the sensing elements Sk in association with a position of the corresponding sensing element Sk on the touch detection unit 32. In one of features of the present invention, a layout and configuration of the sensing elements Sk of the touch detection unit 32 is appropriately set in accordance with a trace of the user's finger, which will be described in detail later.

Under control of the periodic measurement control unit 40 described later, the touch level collection unit 34 inquires a detection result of the touch detection unit 32 at a predetermined timing (e.g., a time interval Δt) and retains the touch level output from the touch detection unit 32 in an memory element which is not shown. After touch levels of all of the sensing elements S1, . . . , S8 are acquired from the touch detection unit 32, the touch level collection unit 34 outputs the touch levels associated with positions of the respective sensing elements Sk of the touch detection unit 32 to the touch position determination unit 36.

The periodic measurement control unit 40 controls timing Δt at which the touch level collection unit 34 makes an inquiry to the touch detection unit 32.

The touch position determination unit 36 determines a location on the touch detection unit 32 with which the user's finger remains in touch, in accordance with a touch level of each of the sensing elements which is detected at predetermined timing Δt and which is output from the touch level collection unit 34.

FIG. 2 shows an example of touch level of each of the sensing elements Sk output from the touch level collection unit 34. FIG. 2 is a diagram showing an example of touch levels of the respective sensing elements Sk used in the touch position determination unit 36. In FIG. 2, detection levels detected by the respective sensing elements S1 to S8 of the touch detection unit 32 are numerically represented at predetermined timing Δt (=0.01 second). For example, as indicated by a hatched area in FIG. 2, the sensing element S1 detects a touch level from 0.000 second to 0.070 seconds. The sensing element S2 detects a touch level from 0.050 seconds to 0.080 seconds. In accordance with the touch level output from each of the sensing elements Sk each time a time elapses as shown in FIG. 2, the touch position determination unit 36 determines a location on the touch detection unit 32 with which the user's finger remains in touch, and outputs a determination result to the touch change management unit 42.

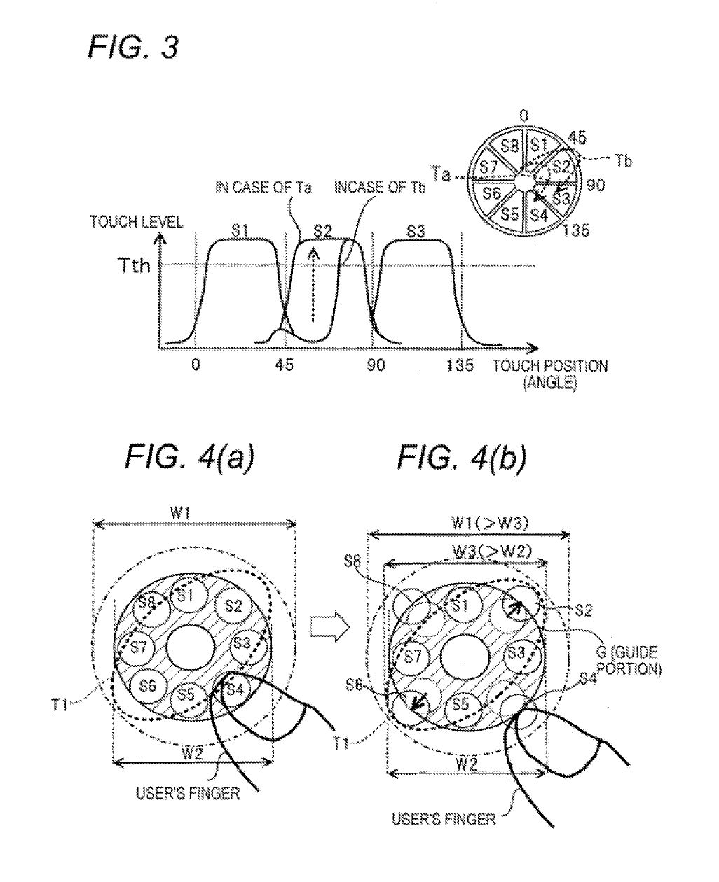

By reference to FIG. 3, a method for determining the touch position determination unit 36 is now described. FIG. 3 is a diagram showing a relationship between a touch position (an angle) of a user's finger and a touch level detected by each of the sensing elements. A vertical axis of FIG. 3 represents a touch level, and a horizontal axis of FIG. 3 represents a touch position of a user's finger in the form of an angle which is relative to one point on a circumference of the touch detection unit 32 taken as an angle of zero degree. An upper right diagram of FIG. 3 schematically shows the touch detection unit 32, and two traces Ta and Tb of the user's finger are illustrated thereon. In FIG. 3, touch levels detected by the respective sensing elements Sk are shown in a single chart for the sake of explanation. However, the touch detection unit 32 detects, for each sensing element, a relationship between a touch position (an angle) of the user's finger and each of touch levels detected by the respective sensing elements Sk.

A touch level of the trace Ta of the user's finger is now described. As shown in an upper right of FIG. 3, the trace Ta of the user's finger stays within sensing ranges of the respective sensing elements S1, S2, and S3. Therefore, the touch level in the case of the trace Ta of the user's finger is a predetermined value Tth or more over the entire sensing ranges except space between the sensing elements, that is, a sensing range from 0 degree to 45 degrees corresponding to a sensing range of the sensing element S1, a sensing range from 45 degrees to 90 degrees corresponding to a sensing range of the sensing element S2, and a sensing range from 90 degrees to 135 degrees corresponding to a sensing range of the sensing element S3.

Although a touch level in the case of the trace Ta of the user's finger illustrated as a constant value in FIG. 3, but may vary. For this reason, even when a fluctuation occurs in the touch level, the touch position determination unit 36 determines that the user's finger remains in touch with the mobile terminal, so long as the touch level is the predetermined value Tth or more.

Next, the trace Tb of the user's finger stays off from the sensing element S2 in a range from 45 degrees to 90 degrees indicating a contact position corresponding to a sensing range of the sensing element S2. In the meantime, the trace Tb of the user's finger stays on the sensing elements S1 and S3 over a range from 0 degree to 45 degrees corresponding to the sensing range of the sensing element S1 and a range from 45 degrees to 90 degrees corresponding to the sensing range of the sensing element S3. Therefore, as shown in FIG. 3, the touch level in the case of the trace Tb of the user's finger shows a low value in a range from a touch position 45 degrees to 90 degrees, where the trace Tb of the user's finger stays off from the sensing element S2. Further, the touch level in the case of the trace Tb of the user's finger maintains the predetermined value Tth or more over a range where the trace Tb of the user's finger stays on the sensing element S2.

As described by reference to FIG. 3, when the trace of the user's finger comes off from the sensing range of the sensing element of the touch detection unit 32, the touch level shows a great fall. So long as the trace of the user's finger falls within the sensing range of the sensing element of the touch detection unit 32, the touch level maintains the predetermined value Tth or more. That is, the touch position determination unit 36 comprehensively determines the touch levels detected by the respective sensing elements S1 to S8, thereby determining which of the sensing elements corresponds to a touch position of the user's finger and a direction in which the finger is moving.

The touch change management unit 42 retains several previous determination results, including the current determination result, output from the touch position determination unit 36 (see FIG. 2). Based on the determination result output from the contact position determination unit 36, the touch change management unit 42 calculates and manages non-release/release of the user's finger, a moving direction of the user's finger, and a moving speed of the user's finger. As used herein, information about non-release/release of the user's finger, a moving direction of the user's finger, and a moving speed of the user's finger is referred to as management information of the touch change management unit 42.

Based on the non-release/release of the user's finger, the moving direction of the user's finger, and the moving speed of the user's finger, all of which are included in the management information of the touch change management unit 42, the item shift determination unit 38 determines whether requirements for switching items of an application 44 focused by a display unit 46 (hereinafter called “focus switching requirements”) are fulfilled. If the trace of the user's finger fulfills the focus switching requirements, the item shift determination unit 38 outputs a signal for shifting a focus to the application 44.

By reference to FIGS. 4 through 7, a layout and configuration of the sensor elements Sk and the guide portion G in the touch detection unit 32, which is one of features of the present invention, are now described. In the present embodiment, the layout and configuration of the sensor elements Sk of the touch detection unit 32 is set according to the moving direction and speed of the user's finger without involvement of an increase in size of the touch detection unit 32. FIGS. 4(a) and 4(b) are diagrams for describing the size of the sensing element Sk and the size of the guide portion G of the touch detection unit 32. For purposes of illustration, the sensing element Sk is depicted by a circle. For the sake of comparison, FIG. 4(a) is a diagram showing a width of a touch detection device of related art required to detect a touch. FIG. 4(b) is a diagram showing a width of the touch detection unit 32 and a width of the guide portion G of the first embodiment.

As shown in the related-art example shown in FIG. 4(a), when the width of the touch detection unit is set so that a trace T1 of the user's finger specified by the shape of an ellipse denoted by a broken line in the drawing can be perfectly detected, a width W1 required to detect a touch grows wider, which makes the rotation detection device 30 larger. For example, in the first related-art example, the width W1 comes to about 28 mm. For this reason, if such a wider touch detection device, such as the first related-art example, is applied to a cellular phone that is a mobile device required to be smaller, the size of the cellular phone will be increased.

Accordingly, as shown in FIG. 4(b), the touch detection unit 32 of the present embodiment is configured so as to allow a part of sensor elements, e.g., the elements S2 and S6, to move to an outside of an outer shape of the touch detection unit 32 defined by the width W2 along its radial direction (an arrow in the drawing) so that a portion of the trace T1 of the user's finger can go out of the outer shape of the touch detection unit 32. For this reason, the width W2 of the touch detection unit 32 can be set so as to become smaller than the width W1 of the related-art example required to detect a touch shown in FIG. 4(a).

The width W2 of the touch detection unit 32 of the present embodiment can be set to about 17 mm, so as to become narrower than the width W1 required to detect a touch shown in FIG. 4(a). Therefore, the rotation detection device 30 of the present embodiment can be applied to a cellular phone, such as a mobile device required to become smaller. Portions of the trace T1 of the user's finger that go out of the touch detection unit 32 correspond to both longitudinal ends of an ellipse (a horizontal width is W3) depicted by a broken line in the drawing. In the present embodiment, the sensor elements S2 and S6 correspond to both longitudinal ends. The width W3 is about 20 mm.

When the rotation detection device 30 of the present embodiment is applied to a cellular phone, such as a mobile device required to become smaller, a part of other sensing elements, e.g., elements S4 and S7, can also be configured so as to move to an outside of the outer shape of the touch detection unit 32 along its radial direction (an arrow shown in the drawing), like the sensing elements S2 and S6, so that, even when the user's finger is a left thumb, the finger becomes compatible with the cellular phone.

A range of the sensing elements S1 to S8 of the touch detection unit 32 defined by the width W2 shown in FIG. 4(b) corresponds to a range where the sensing elements S1 to S8 of the touch detection unit 32 operates. The range is hereunder referred to as a range where the touch detection unit 32 can detect a touch. Moreover, an area represented by a line (a solid line in the drawing) that depicts an outer shape of the touch detection unit 32 specified by the width W2 shown in FIG. 4(b) serves as the guide (the guide portion G for guiding a touch position of a finger) for letting the user visually recognize a range where the sensing elements Sk operate. The sensing elements Sk are arranged such that a part of the sensing elements Sk is situated outside the guide portion G. In addition to being one that lets the user visually recognize the range where the sensor element Sk operates, the guide portion G may be one that lets the user tangibly recognize the range or one that lets the user visually and tangibly recognize the range.

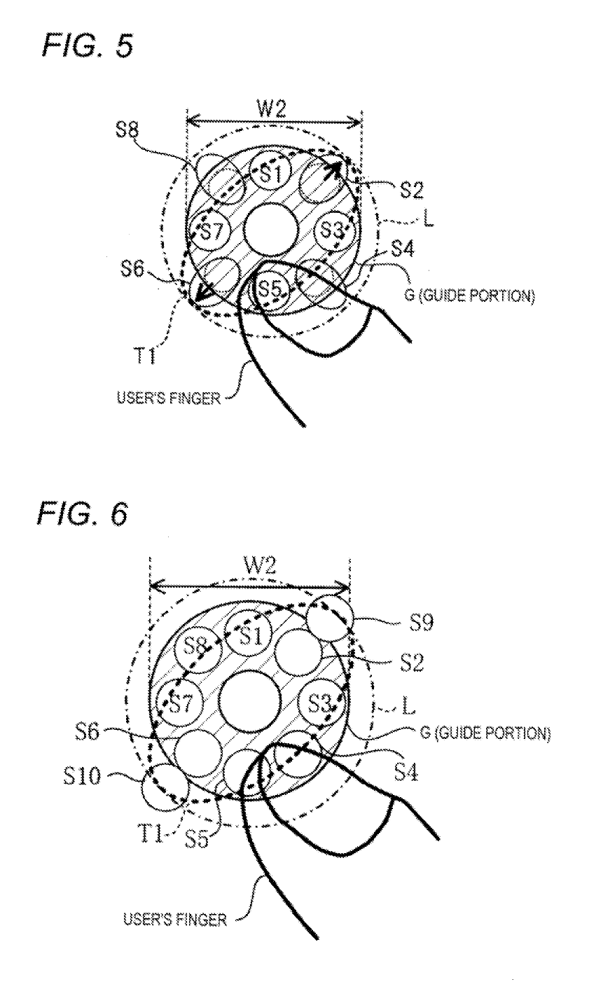

By reference to FIGS. 5 through 8, modifications (1) to (3) of the touch detection unit 32 of the rotation detection device 30 of the present embodiment are now described. A trace T1 shown in FIGS. 5 through 7 is identical with the trace T1 of the user's finger shown in FIG. 4. Moreover, a dashed line L shown in FIGS. 5 through 7 indicates an outer shape of the related-art wide touch detection device shown in FIG. 4(a) for comparison purpose. When the modifications (1) through (3) of the touch detection unit 32 shown in FIGS. 5 through 8 are applied to the rotation detection device 30 of the present embodiment, the touch detection units 32 of the modifications (1) through (3) are employed in place of the touch detection unit 32 of the rotation detection device 30 shown in FIG. 1.

FIG. 5 is a diagram showing the modification (1) of the touch detection unit 32. In the modification (1) of the touch detection unit 32 shown in FIG. 5, the sensing elements situated at positions where the trace of the user's finger goes out of the guide portion G of the touch detection unit 32 are made larger than the other sensing elements.

As shown in FIG. 5, the sensing elements S2 and S6 situated at positions where the trace T1 of the user's finger goes out of the guide portion G of the touch detection unit 32 are changed so as to include a range where the trace T1 of the user's finger situated off the guide portion G of the touch detection unit 32 passes, whereby the touch detection unit 32 can detect a touch of the user's finger.

Moreover, in the modification (1), the sensing elements S4 and S8 are also changed in size in the same manner as are the sensing elements S2 and S6. As a result, the rotation detection device 30 can be configured such that the user's finger does not go out of the range where the touch detection unit 32 can detect a touch even when the user's finger is the left thumb. Specifically, if the modification (1) of the touch detection unit 32 shown in FIG. 5 is applied in lieu of the rotation detection device 30 shown in FIG. 1, the rotation detection device 30 can detect a touch of the user's finger regardless of whether the user's hand is left or right.

FIG. 6 is a diagram showing the modification (2) of the touch detection unit 32. In the modification (2) of the touch detection unit 32 shown in FIG. 6, a group of new sensing elements S9 and S10 are placed at positions where the trace T1 of the user's finger goes out of the guide portion G of the touch detection unit 32, that is, outside the guide portion G, in contrast to the group of sensing elements S1 to S8 in the guide portion G of the touch detection unit 32.

As shown in FIG. 6, the new sensing elements S9 and S10 that covers a range where the trace T1 of the user's finger goes out of the guide portion G of the touch detection unit 32 are placed further outside the sensing elements S2 and S6 for which the trace T1 of the user's finger is situated within the guide portion G of the touch detection unit 32. Therefore, the rotation detection device 30 can detect a touch of the user's finger. At this time, the sensing elements S2 and S9 act as a single sensing element. Likewise, the sensing elements S6 and S10 act as a single sensing element.

In the modification (2) of the touch detection unit 32 shown in FIG. 6, the new sensing elements S9 and S10 can also be placed outside the sensing elements S4 and S8 as in the case of the modification (1) of the touch detection unit 32 shown in FIG. 5. In this case, even when the user's finger belongs to the left hand, the rotation detection device 30 can be configured such that the user's finger does not go out of the range where the touch detection unit 32 can detect a touch.

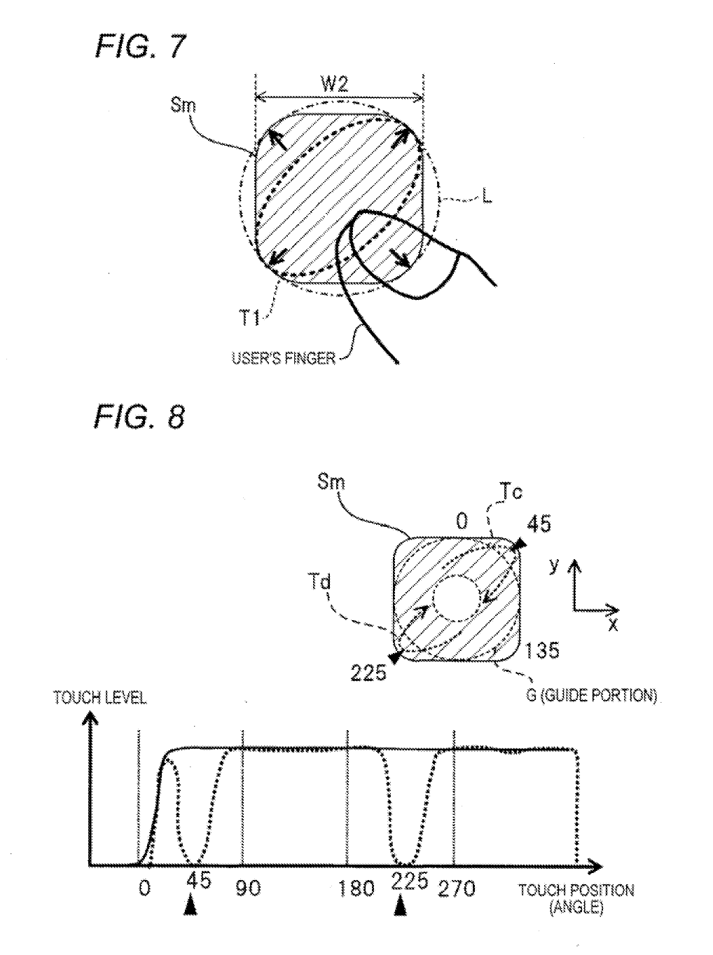

FIG. 7 is a diagram showing the modification (3) of the touch detection unit 32. In the modification (3) of the touch detection unit 32 shown in FIG. 7, the touch detection unit 32 including the plurality of sensing elements S1 to S8 is built from a single sensing element Sm.

As shown in FIG. 7, the rotation detection device 30 can detect a touch of the user's finger by means of a width that is substantially identical with the width W2 defined by the outer shape of the touch detection unit 32 of the embodiment shown in FIG. 4(b), so long as the single sensing element Sm is given a substantially square shape whose diagonal line corresponds to the major axis of the trace T1 of the user's finger. In this case, even when the user's finger belongs to the left hand, the rotation detection device 30 can be configured such that the user's finger does not go out of the range where the touch detection unit 32 can detect a touch. The guide portion G (not shown) is placed in such a way that at least a portion of the sensing element Sm is situated outside the guide portion G.

By reference to FIG. 8, an explanation is given to a method for determining the touch position determination unit 36 when the touch detection unit 32 is built from a single sensing element Sm. FIG. 8 is a diagram showing a relationship between a touch position (an angle) and a touch level of the user's finger achieved when the touch detection unit 32 includes a single sensing element Sm. A vertical axis of FIG. 8 represents a touch level, whilst a horizontal axis of FIG. 8 represents a touch position of the user's finger in the form of an angle relative to a certain point on the circumference of the touch detection unit 32 that is taken as an angle of zero degree. Two traces Tc and Td of the user's finger are provided in an upper right position of FIG. 8 that schematically shows the touch detection unit 32. The rotation detection device 30 shown in FIG. 8 has a guide (namely, a guide portion G for guiding a touch position of a finger) for letting the user visually recognize the range where the sensing element Sm operates. At least a part of the sensing elements Sm is situated outside the guide portion G.

When the touch detection unit 32 includes a single sensing element Sm, the touch position is calculated, for example, from rectangular coordinates (an x-axis and a y-axis) of a plane that takes the center of the touch detection unit 32 as a point of origin. The touch position determination unit 36 determines, from a touch level of the touch position, a location on the touch detection unit 32 where the user's finger is situated.

As shown in FIG. 8, the trace Tc of the user's finger goes out of a sensing range of the touch detection unit 32 at a touch position in the vicinity of an angle of 45°, and a touch level substantially comes to zero. Likewise, the trace Td of the user's finger goes out of the sensing range of the touch detection unit 32 at a touch position in the vicinity of an angle of 225°, so that the contact level assumes a value of about zero. As mentioned above, when a touch level achieved at the touch position comes to zero, the touch position determination unit 36 determines that the user's finger is situated outside the touch detection unit 32.

Any of the modifications (1) to (3) of the touch detection unit 32 shown in FIGS. 5 through 7 is applied without modification to the rotation detection device 30 in place of the touch detection unit 32 of the rotation detection device shown in FIG. 1, so that a touch of the user's finger can be detected.

In the rotation detection device 30 of the embodiment, when the device itself is small-sized and when the user's finger performs rotational operation with respect to the touch detection unit 32, the trace of the user's finger does not go out of sensing ranges of the plurality of sensing elements S1 through S8 of the touch detection unit 32. Therefore, the rotation detection device 30 of the present embodiment can detect the touch of the user's finger.

In the rotation detection device 30 of the present embodiment, the sensing elements Sk of the touch detection unit 32 are of electrostatic capacitance type (surface type). However, the sensing elements are not limited to the capacitance type. The sensing elements Sk of the touch detection unit 32 can be of any type, e.g., capacitance type (projection type), resistance film type (pressure sensitive type), or electromagnetic induction type.

In the rotation detection device 30 of the present embodiment, the item shift determination unit 38 determines whether the trace of the user's finger satisfies focus switching requirements. The rotation detection device can be configured so as to output a focus shift signal to the application 44 that makes up a portion of an external device, according to a determination result. The display unit 46 serving as a portion of the external device switches items of the application 44 displayed on the display unit, in accordance with the signal.

When the rotation detection device 30 of the present embodiment is applied to a cellular phone that is a mobile device required to become smaller, the rotation detection device can preferably be configured so as to respond to a case where the user's finger is the left thumb, in such a way that, like the sensing elements S2 and S6, the sensing elements S4 and S7 are movably configured so as to go out of the outer shape of the touch detection unit 32 in its radial direction (an arrow in the drawing).

### Second Embodiment

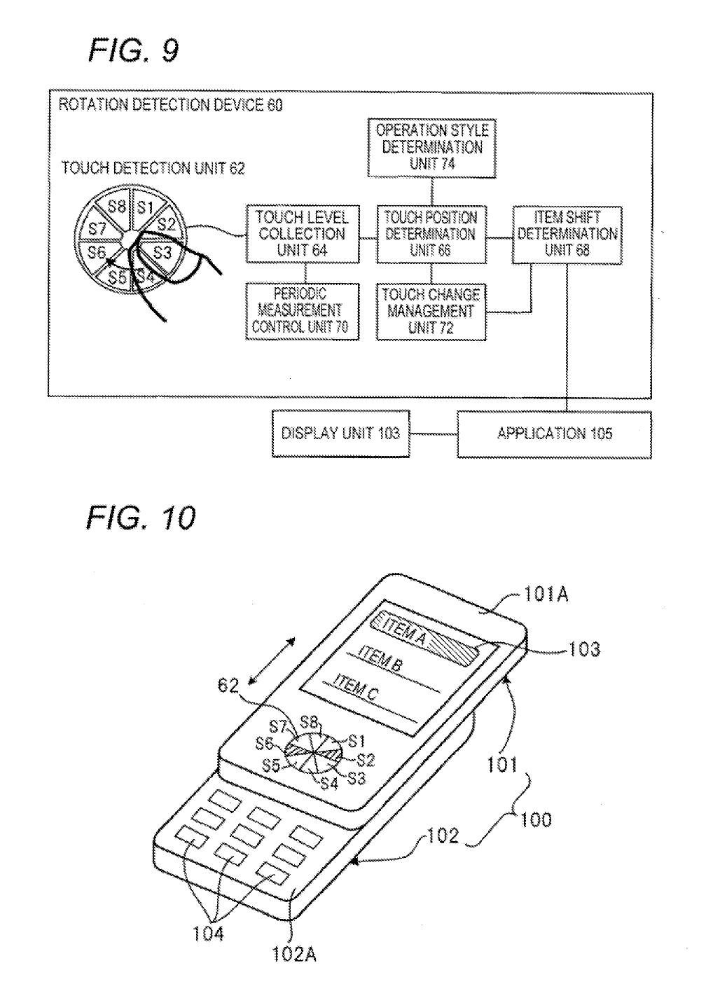

An explanation is now given to a case where a rotation detection device 60 of a second embodiment is applied to a slider cellular phone 100. There are omitted explanations about portions of the rotation detection device 60 that are similar to those of the rotation detection device 30 of the first embodiment modifications similar to those described in connection with the first embodiment also apply to the rotation detection device 60 unless otherwise mentioned. FIG. 9 is a block diagram showing a configuration of the rotation detection device 60 of the second embodiment. The rotation detection device 60 shown in FIG. 9 includes a touch detection unit 62, a touch level collection unit 64, a touch position determination unit 66, an item shift determination unit 68, a periodic measurement control unit 70, a touch change management unit 72, and an operation style determination unit 74.

In the embodiment, the user is assumed to grip the slider cellular phone 100 with his/her right hand and operate the touch detection unit 62 with a right thumb (hereinafter called a user's finger) that grips the slider cellular phone 100.

The touch detection unit 62 includes a plurality of sensing elements Sk (k=1, . . . , n: “n” is a natural number) capable of detecting a state of touch of the user's finger. In the present embodiment, “k” is eight, and the touch detection unit 62 includes eight sensing elements. An outer shape of the touch detection unit 62 is circular and circumferentially segmented at predetermined angles or intervals along. The sensing element Sk is placed in each of the segments. An outer shape of the sensing element Sk is a substantially fan shape conforming to each of the segments of the touch detection unit 62. Since the guide portion G is similar to its counterpart described in connection with the first embodiment, its explanation is omitted here for brevity.

In response to an inquiry from the touch level collection unit 64 to be described later, the touch detection unit 62 outputs, to the touch level collection unit 64, a numeral (hereinafter called a “touch level”) according to a degree of touch of a user's finger detected by each of the sensing elements Sk and in association with a position of the corresponding sensing element Sk on the touch detection unit 62.

Under control of the periodic measurement control unit 70 to be described later, the touch level collection unit 64 inquires a detection result of the touch detection unit 62 at a predetermined timing Δt and retains the touch level output from the touch detection unit 62 in a memory element which is not shown. After touch levels of all of the sensing elements S1, . . . , S8 are acquired from the touch detection unit 62, the touch level collection unit 64 outputs the touch levels associated with positions of the respective sensing elements Sk of the touch detection unit 62 to the touch position determination unit 66.

The periodic measurement control unit 70 controls timing et at which the touch level collection unit 64 makes an inquiry to the touch detection unit 62.

The operation style determination unit 74 determines a usage state of the slider cellular phone 100. Based on a determination result, the operation style determination unit 74 previously outputs, to the touch position determination unit 66, prerequisites to changing “requirements of the sensing elements,” e.g., a usage state of the slider cellular phone 100 and positional information about sensing elements located at positions where the trace of the user's finger is to go out of the guide portion G of the touch detection unit 62. A determination method of the operation style determination unit 74 will be described later.

The touch position determination unit 66 determines a location on the touch detection unit 62 with which the user's finger remains in touch, in accordance with a touch level of each of the sensing elements Sk that is detected at predetermined timing Δt by virtue of a result output from the operation style determination unit 74 and that is output from the touch level collection unit 64. The touch position determination unit 66 outputs the determination result to the touch change management unit 72.

The touch change management unit 72 retains several previous determination results, including the current determination result, output from the touch position determination unit 66. The touch change management unit 72 calculates, from the determination result output from the touch position determination unit 66, non-release/release of the user's finger, a moving direction of the user's finger, and a moving speed of the user's finger, and manages calculation results. As used herein, information about non-release/release of the user's finger, a moving direction of the user's finger, and a moving speed of the user's finger is referred to as management information of the touch change management unit 72.

Based on the non-release/release of the user's finger, the moving direction of the user's finger, and the moving speed of the user's finger, all of which are included in the management information of the touch change management unit 72, the item shift determination unit 68 determines whether focus switching requirements for switching items of an application 105 focused by a display unit 103 of the slider cellular phone 100 are fulfilled. If the trace of the user's finger fulfills the focus switching requirements, the item shift determination unit 68 outputs a focus shift signal to the application 105.

By reference to FIGS. 9 through 11, the determination method of the operation style determination unit 74 is now described.

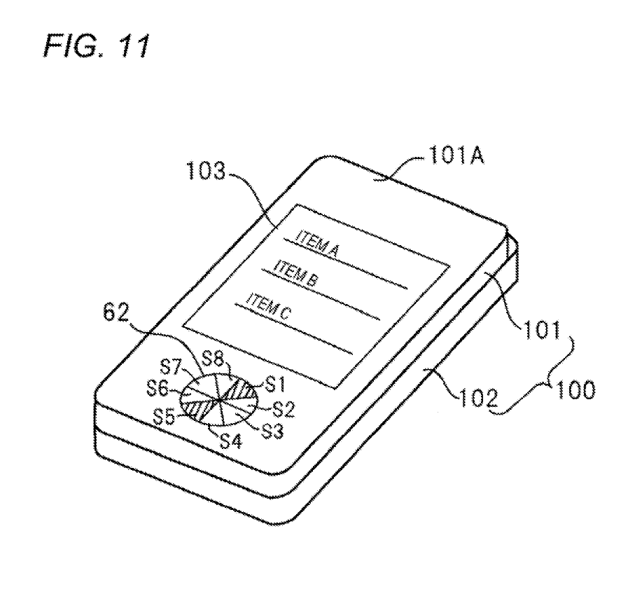

A configuration of the slider cellular phone 100 is first described by reference to FIGS. 10 and 11. FIGS. 10 and 11 are diagrams showing a usage state of the slider cellular phone 100. FIG. 10 is a diagram showing an extended state of the slider cellular phone 100, and FIG. 11 is a diagram showing a closed state of the slider cellular phone 100.

The slider cellular phone 100 comprises an upper housing 101 serving as a first housing and a lower housing 102 serving as a second housing. The upper housing 101 and the lower housing 102 are connected together so as to relatively slide.

Operation keys 104 serving as an operation unit that becomes exposed in an extended state of the slider cellular phone 100 are placed on a principal surface 102A of the lower housing 102.

The touch detection unit 62 of the rotation detection device 60 of the second embodiment is placed, in a lower portion of a principal surface 101A of the upper housing 101. The display unit 103 that covers substantially the entirety of a remaining portion of the principal surface 101A is provided.

The display unit 103 can display items, e.g., an item A to an item C, of the application 105 installed in the slider cellular phone 100. Based on a detection result yielded by the touch detection unit 62 provided on the principal surface 101A, the rotation detection device 60 can switch the item A of the application 105 focused by the display unit 103 of the slider cellular phone 100 to another item B or the item C.

As shown in FIG. 10, when a telephone call or a mail is made by use of the slider cellular phone 100, the upper housing 101 and the lower housing 102 are slidably extended, thereby rendering the operation keys 104 provided in the lower housing 102 exposed. In the closed state shown in FIG. 11, the operation keys 104 provided in the lower housing 102 remain concealed, whilst the touch detection unit 62 of the rotation detection device 60 remains exposed.

In the present embodiment, like the touch detection unit 32 described by reference to FIG. 4(b), the touch detection unit 62 is configured in such a way that a part of the sensing elements is configured to move toward an outside of the touch detection unit 62 along its radial direction (an arrow in the drawing) so that portions of the trace of the user's finger can go out of the outer shape of the touch detection unit 62. The configuration, therefore, allows application of the rotation detection device 60 to the slider cellular phone 100 that is a mobile device required to become smaller.

The sensing elements that are configured to move toward an outside of the touch detection unit 62 along its radial direction correspond to the sensing elements S2 and S6 in the extended state of the slider cellular phone 100 shown in FIG. 10. Further, the sensing elements configured to move toward an outside of the touch detection unit 62 along its radial direction (an arrow in the drawing) correspond to the sensing elements S1 and S5 in the closed state of the slider cellular phone 100 shown in FIG. 11.

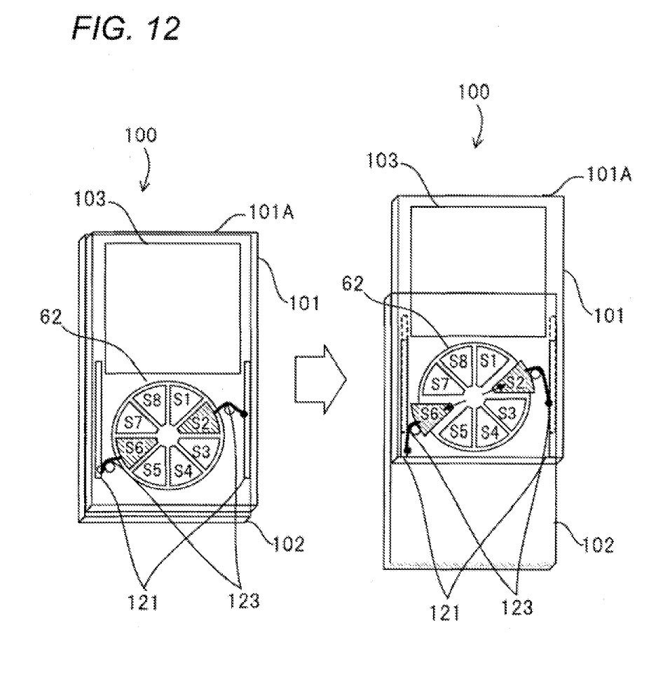

By reference to FIG. 12, there is now given an explanation of an example in which a part of the sensing elements is configured to move toward an outside of the touch detection unit 62 in its radial direction (the arrow in the drawing). FIG. 12 is a diagram showing a configuration in which a part of the sensing elements move toward an outside of the touch detection unit 62. As shown in FIG. 12, the slider cellular phone 100 is configured as follows. Specifically, when the slider cellular phone 100 shifts from a closed state shown in FIG. 11 to an extended state shown in FIG. 10 by means of slide connection means 121 that movably connects the upper housing 101 to the lower housing 102 by sliding the upper housing 101 and the lower housing 102 relatively to each other, a part of sensing elements, i.e., the sensing elements S2 and S6, move toward an outside of the touch detection unit 62 along its radial direction (the arrow in the drawing) by connection means (a wire or the like) 123 that connects the sensing elements S2 and S6 to the slide connection means 121.

The operation style determination unit 74 determines, as usage states of the slider cellular phone 100, the extended state of the slider cellular phone 100 shown in FIG. 10 and a closed state of the slider cellular phone 100 shown in FIG. 11

For example, in the closed state of the slider cellular phone 100 shown in FIG. 11, the operation style determination unit 74 previously outputs a determination result showing a closed state to the touch position determination unit 66 as a usage state of the slider cellular phone 100. Based on an output result of the operation style determination unit 74 and the touch levels of the respective sensing elements Sk output from the touch level collection unit 64, the touch position determination unit 66 determines a position on the contact detection unit 62 with which the user's finger remains touch.

In the extended state of the slider cellular phone 100 shown in FIG. 10, the operation style determination unit 74 previously outputs a determination result showing an extended state to the touch position determination unit 66 as a usage state of the slider cellular phone 100. Based on the output result of the operation style determination unit 74 and the touch levels of the respective sensing elements output fro the touch level collection unit 64, the touch position determination unit 66 determines a position on the contact detection unit 62 which the user's finger remains in touch with.

In the rotation detection device 60 of the present embodiment, when the device itself is small-sized and when the user's finger performs rotational operation with respect to the touch detection unit 62, the trace of the user's finger does not go out of the sensing range of the plurality of sensing elements S1 to S8 of the touch detection unit 62. Therefore, the rotation detection device 60 of the present embodiment can detect a touch of the user's finger.

In the rotation detection device 60 of the present embodiment, the sensing elements Sk of the touch detection unit 62 are of electrostatic capacitance type (surface type). However, the sensing elements are not limited to the capacitance type. The sensing elements Sk of the touch detection unit 62 can be of any type, e.g., electrostatic capacitance type (projection type), resistance film type, or electromagnetic induction type.

When the rotation detection device 60 of the present embodiment is applied to a cellular phone that is a mobile device required to become smaller, the rotation detection device can preferably be configured so as to respond to a case where the user's finger is the left thumb in such a way that, like the sensing elements S2 and S6, the sensing elements S4 and S7 are configured to move to outside of the outer shape of the touch detection unit 62 in its radial direction.

In connection with the rotation detection device 60 of the present embodiment, the touch detection unit 62 is described as being identical in configuration with the touch detection unit 32 described by reference to FIG. 4(b). However, the touch detection unit 62 is not limited to the configuration. Any one of the modification (1) of the touch detection unit 32 described by reference to FIG. 5, the modification (2) of the touch detection unit 32 described by reference to FIG. 6, and the modification (3) of the touch detection unit 32 described by reference to FIG. 7 can be applied to the touch detection unit 62.

Even when any of the modifications of the touch detection unit 32 is applied to the touch detection unit 62 of the rotation detection device 60 of the embodiment, positional information about the sensing elements situated at positions where the trace of the user's finger goes out of the guide portion G of the contact detection unit 62, which is one of prerequisites for changing the “requirements of the sensing elements,” corresponds to the sensing elements S2 and S6 in the extended state of the slider cellular phone 100 shown in FIG. 10 and the sensing elements S1 and S5 in the closed state of the slider cellular phone 100 shown in FIG. 11.

### Third Embodiment

An explanation is now given to a case where a rotation detection device 80 of a third embodiment is applied to a flip cellular phone 300. There are omitted explanations about portions of the rotation detection device 80 that are similar to those of the rotation detection device 30 of the first embodiment or the second embodiment. Modifications similar to those described in connection with the first embodiment or the second embodiment also apply to the rotation detection device 80 unless otherwise mentioned.

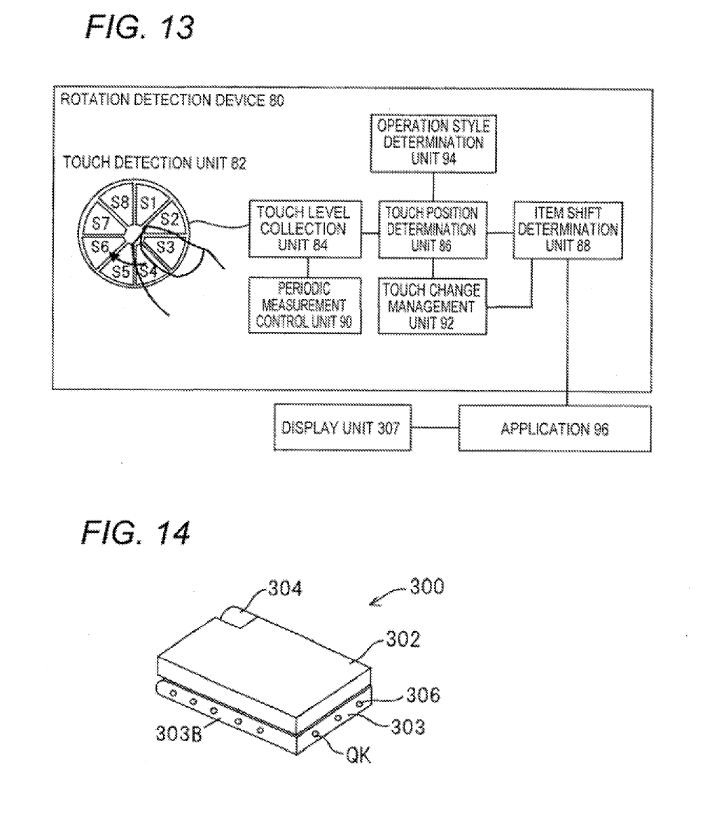

FIG. 13 is a block diagram showing a configuration of the rotation detection device 80 of the third embodiment. The rotation detection device 80 shown in FIG. 13 includes a touch detection unit 82, a touch level collection unit 84, a touch position determination unit 86, an item shift determination unit 88, a periodic measurement control unit 90, a touch change management unit 92, and an operation style determination unit 94.

In the embodiment, the user is assumed to grip the flip cellular phone 300 with his/her right hand and operate the touch detection unit 82 with the right thumb (hereinafter called a user's finger) that grips the flip cellular phone 300.

The touch detection unit 82 includes a plurality of sensing elements Sk (k=1, . . . , n: “n” is a natural number) capable of detecting a state of touch of the user's finger. In the present embodiment, “k” is eight, and the touch detection unit 82 includes eight sensing elements Sk. An outer shape of the touch detection unit 82 is circular and circumferentially segmented at predetermined angles or intervals along. The sensing element Sk is placed in each of the segments. An outer shape of the sensing element Sk is a substantially fan shape conforming to each of the segments of the touch detection unit 82. Since the guide portion G is similar to its counterpart described in connection with the first embodiment, its explanation is omitted here for brevity.

In response to an inquiry from the touch level collection unit 84 to be described later, the touch detection unit 82 outputs, to the touch level collection unit 84, a numeral (hereinafter called a “touch level”) according to a degree of touch of a user's finger detected by each of the sensing elements Sk and in association with a position of the corresponding sensing element Sk on the touch detection unit 82.

In the present embodiment, like the touch detection unit 32 described by reference to FIG. 4(b), the contact detection unit 82 is configured such that a part of of the sensing elements is configured to move toward an outside of the touch detection unit 82 along its radial direction so that portions of the trace of the user's finger can go out of the outer shape of the touch detection unit 82. The configuration, therefore, allows application of the rotation detection device 80 to the flip cellular phone 300 that is a mobile device required to become smaller. In the present embodiment, a part of the sensing elements is configured to move toward an outside of the touch detection unit 82 in its radial direction are previously set.

Under control of the periodic measurement control unit 90 to be described later, the touch level collection unit 84 inquires a detection result of the touch detection unit 82 at a predetermined timing Δt and retains the touch level output from the touch detection unit 82 in an unillustrated memory element. After touch levels of all of the sensing elements S1, . . . , S8 are acquired from the touch detection unit 82, the touch level collection unit 84 outputs the touch levels associated with positions of the respective sensing elements Sk of the touch detection unit 82 to the touch position determination unit 86.

The periodic measurement control unit 90 controls timing Δt at which the touch level collection unit 84 makes an inquiry to the touch detection unit 82.

The operation style determination unit 94 determines a usage state of the flip cellular phone 300 based on a detection result of another touch detection unit 306 provided on a side surface 303B of a lower housing 303 of the flip cellular phone 300 to be described later.

The word “usage state of the flip cellular phone 300” means whether the flip cellular phone 300 is operated in a first open state or a second open state by way of the touch detection unit 82 with the user's finger (the right thumb in the present embodiment).

The operation style determination unit 94 outputs a usage state of the flip cellular phone 300 and preset positional information about a part of sensing elements located at positions where the trace of the user's finger is to go out of the guide portion G of the touch detection unit 82 to the touch position determination unit 86 as prerequisites to changing “requirements of the sensing elements.” A determination method of the operation style determination unit 94 for determining a usage state of the flip cellular phone 300 will be described later.

The touch position determination unit 86 determines a location on the touch detection unit 82 with which the user's finger remains in touch, in accordance with an output result from the operation style determination unit 94 and a touch level of each of the sensing elements output from the touch level collection unit 84. The touch position determination unit 86 outputs the determination result to the touch change management unit 92.

The touch change management unit 92 retains several previous determination results, including the current determination result, output from the touch position determination unit 86. The touch change management unit 92 calculates, from the determination result output from the touch position determination unit 86, non-release/release of the user's finger, a moving direction of the user's finger, and a moving speed of the user's finger, and manages calculation results. As used herein, information about non-release/release of the user's finger, a moving direction of the user's finger, and a moving speed of the user's finger is referred to as management information of the touch change management unit 92.

Based on the non-release/release of the user's finger, the moving direction of the user's finger, and the moving speed of the user's finger, all of which are included in the management information of the touch change management unit 92, the item shift determination unit 88 determines whether focus switching requirements for switching items of an application 96 focused by a display unit 307 of the flip cellular phone 300 are fulfilled. When the trace of the user's finger fulfills the focus switching requirements, the item shift determination unit 88 outputs a focus shift signal to the application 96.

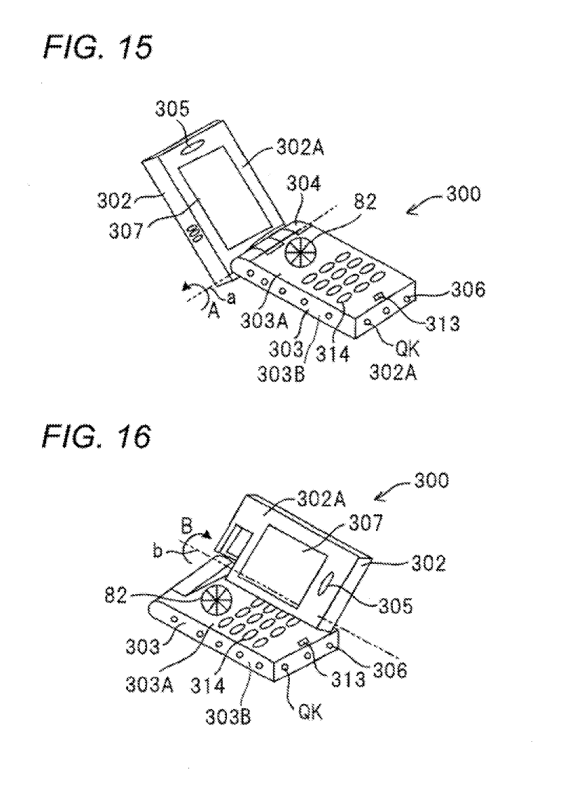

By reference to FIGS. 14 through 16, a state of the flip cellular phone 300 is now described. FIG. 14 shows a closed state of the flip cellular phone 300; FIG. 15 shows a first open state of the flip cellular phone 300; and FIG. 16 shows a second open state of the flip cellular phone 300.

As shown in FIG. 14, the flip cellular phone 300 roughly includes a substantially-box-shaped upper housing 302 serving as a first housing, the substantially-box-shaped lower housing 303 serving as a second housing, and a connecting portion 304 that connects the upper housing 302 to the lower housing 303 so as to able to open and close. The flip cellular phone 300 is connected so as to open and close by rotating action of the connection portion 304, around a shaft center “a” (a first rotation shaft) in an arrow-head direction A (a first rotating direction) and around, in an arrow-head direction B (a second rotating direction), a shaft center “b” (a second rotation shaft) orthogonal to the arrow-head direction A.

While being carried, the flip cellular phone 300 is used in a state in which the upper housing 302 and the lower housing 303 of the flip cellular phone 300 are superimposed (closed state) with each other, as shown in FIG. 14. For example, when a text, numerals, or a phone number is input during telephone call, the flip cellular phone 300 is used in a primary open state (a first open state or a vertically open state) in which the upper housing 302 is turned, from its closed state, around the shaft center “a” with respect to the lower housing 303 in the arrow-head direction A, such as that shown in FIG. 15. For example, in a case where TV is watched on a landscape screen, the flip cellular phone 300 is used in a secondary open state (a second open state or a horizontally open state) in which the upper housing 302 is turned, from its closed state, around the shaft center “b” with respect to the lower housing 303 in the arrow-head direction B, such as that shown in FIG. 16.

By reference to FIG. 15, the configuration of the flip cellular phone 300 of the present embodiment is now described. The upper housing 302 accommodates a receiver 305 and the display unit 307. The display unit 307 is provided on a principal surface 302A of the upper housing 302.

The lower housing 303 accommodates a mouthpiece (microphone) 313 and operation keys 314 that serve as an operation unit. The operation keys 314 serving as the operation unit that becomes exposed when the flip cellular phone 300 is in the first or second open state is provided on a principal surface 303A of the lower housing 303. In the embodiment, the lower housing 303 is made of resin, in the same manner as is the upper housing 302. However, the lower housing 303 is not limited to the resin.

Another touch detection unit 306 is provided at equal intervals over all circumferences of the lower housing 303, i.e., four side surfaces 303B, in order to detect touches of fingers other than the finger (the thumb in the present embodiment) used by the user to operate the touch detection unit 82 or a touch of a hand (the right hand in the present embodiment) by means of a plurality of sensing elements Qk (k=1, . . . , “n”: “n” is a natural number). In the present embodiment, “n” is sixteen. Five sensing elements Qk are provided on each of two longitudinal side surfaces of the lower housing 303. Further, three sensing elements Qk are provided on each of two lateral side surfaces of the lower housing 303.

Another touch detection unit 306 is electrically connected to the foregoing operation style determination unit 94 and output a detection result of the plurality of sensing elements Qk to the operation style determination unit 94.

The microphone 313 is embedded in the principal surface 303A of the lower housing 303 and set in such a way that, when the flip cellular phone 300 is closed, the upper housing 302 covers the microphone 313 in an opposing manner and that, when the flip cellular phone 300 is in the first or second open state, the microphone 313 becomes exposed. During a phone call, the microphone transmits a user's voice to the party at the other end.

The operation keys 314 serving as the operation unit are arranged on the principal surface 303A of the lower housing 303. In order to input a phone number and a text, numerals, letters, and symbols are printed on each of the operation keys 314. The operation keys include a plurality of operation buttons that enable receipt and termination of a call, control of the volume of sound output from the receiver 305, switching of a mode to a manner mode, and selection and determination of a menu on a menu screen.

The connection portion 304 includes a hinge which is not shown, and rotatably connects the upper housing 302 to the lower housing 303.

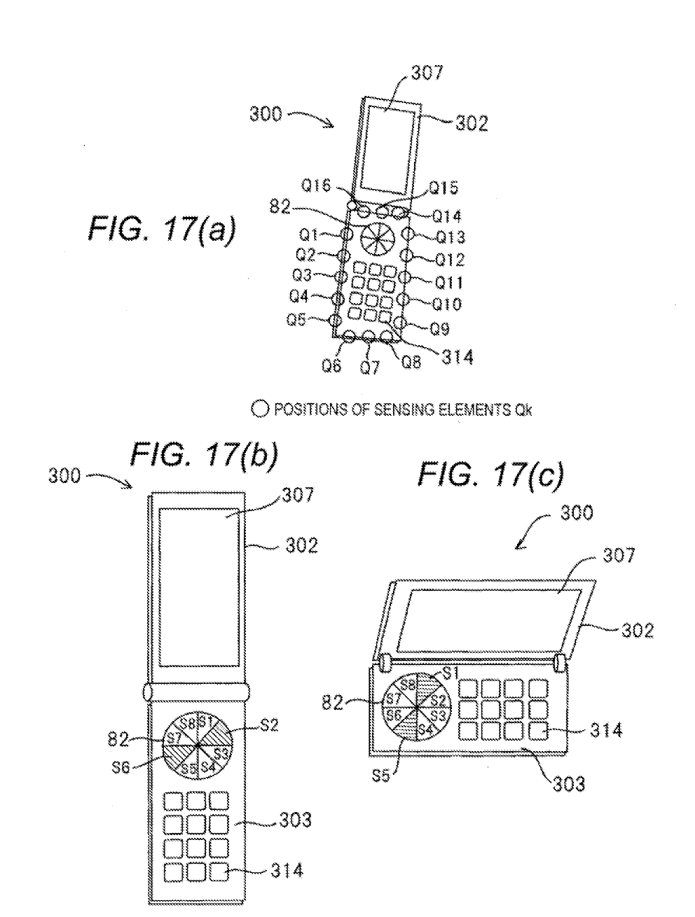

By reference to FIG. 17, a method for determining a “usage state of the flip cellular phone 300” employed by the operation style determination unit 94 is now described. FIG. 17(a) is a diagram showing positions of the plurality of sensing elements Q1 to Q16. FIG. 17(b) is a diagram showing a position of a part of the sensing elements which is configured to move toward an outside of the touch detection unit 82 along its radial direction in the first open state. FIG. 17(c) is a diagram showing a position of a part of the sensing elements which is configured to move toward an outside of the touch detection unit 82 along its radial direction in the second open state.

As shown in FIG. 17(c), the operation style determination unit 94 determines (1) or (2), which will be described below, as a usage state of the flip cellular phone 300 based on detection results of the plurality of sensing elements Q1 to Q16 of another touch detection unit 306 provided on the side surfaces 303B of the lower housing 303. Namely, (1) is a first open state shown in FIG. 17(b) in which the user's finger (the right thumb in the present embodiment) operates the flip cellular phone 300 by way of the touch detection unit 82. (2) is a second open state shown in FIG. 17(c) in which the user's finger (the right thumb in the present embodiment) operates the flip cellular phone 300 by way of the touch detection unit 82.

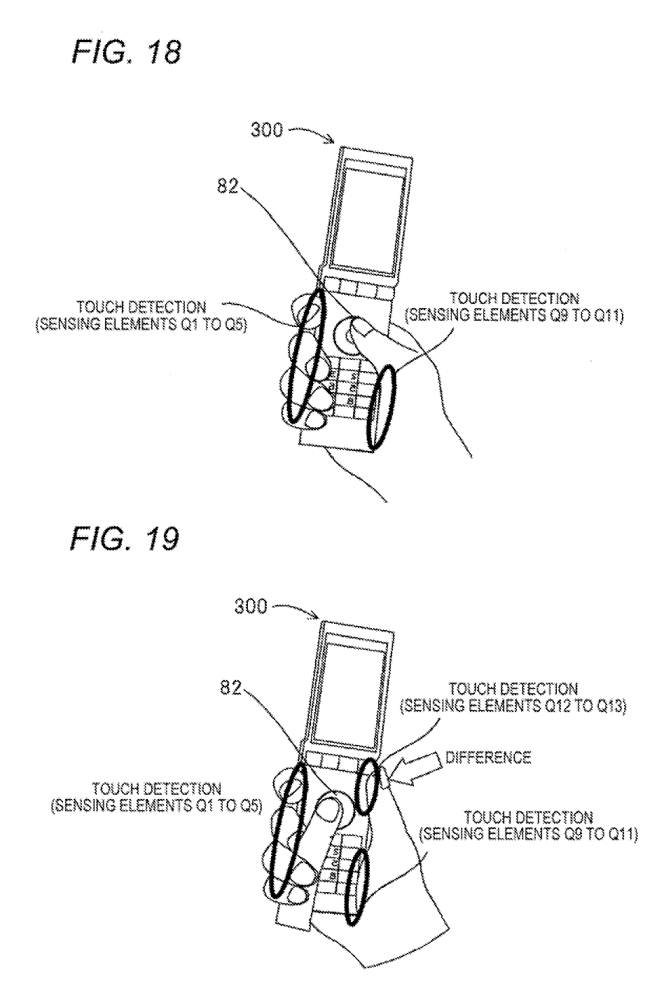

For example, FIG. 18 shows a first example of detection performed by another touch detection unit 306. When the user's finger (the right thumb in the present embodiment) operates the flip cellular phone 300 in the first open state by way of the touch detection unit 82, the sensing elements Q1 to Q5 configuring a part of another touch detection unit 306 detect touches of other fingers (i.e., fingers other than the thumb) of the user. The sensing elements Q9 to Q11 of a part of another detection unit 306 can detect a touch of a root of the user's finger (the right thumb in the present embodiment).

As shown in FIG. 17(b), when the flip cellular phone 300 is in the first open state and when the user's finger (the right thumb in the present embodiment) operates the flip cellular phone 300 by way of the touch detection unit 82, preset “positional information about a part of sensing elements situated at a position where the trace of the user's finger goes out of the guide portion G of the touch detection unit 82” corresponds to the positional information about the sensing elements S2 and S6.

As shown in FIG. 17(c), when the user's finger (the right thumb in the present embodiment) operates the flip cellular phone 300 by way of the touch detection unit 82 while the flip cellular phone 300 is in the second open state, preset “positional information about a part of sensing elements situated at a position where the trace of the user's finger goes out of the guide portion G of the touch detection unit 82” corresponds to positional information about the sensing elements S1 and S5.

When the rotation detection device 80 of the embodiment itself is small-sized and when the user's finger performs rotational operation with respect to the touch detection unit 82, the trace of the user's finger will not go out of the sensing range of the plurality of sensing elements S1 to S8 of the touch detection unit 82. Therefore, the rotation detection device 80 of the present embodiment can detect a touch of the user's finger by means of the touch detection unit 82.

In the rotation detection device 80 of the present embodiment, the sensing elements Sk of the touch detection unit 82 are of electrostatic capacitance (surface type). However, the sensing elements are not limited to the electrostatic capacitance type. The sensing elements Sk of the touch detection unit 82 can be of any type, e.g., electrostatic capacitance type (projection type), resistance film type, or electromagnetic induction type. Likewise, the sensing elements Qk of another touch detection unit 306 are of electrostatic capacitance type (surface type). However, the sensing elements Qk are not limited to the electrostatic capacitance type. The sensing elements Qk can be of any type, e.g., electrostatic capacitance type (projection type), resistance film type, or electromagnetic induction type.

When the rotation detection device 80 of the embodiment is applied to a cellular phone that is a mobile device required to become smaller, the rotation detection device 80 can cope with a case where the user's finger is the left thumb. In this case, when the flip cellular phone 300 is in the first open state and when the user's finger (the left thumb) operates the flip cellular phone 300 by way of the touch detection unit 82, the preset “positional information about a part of sensing elements situated at a position where the trace of the user's finger goes out of the guide portion G of the touch detection unit 82” corresponds to positional information about the sensing elements S1 and S5. As shown in FIG. 17(c), when the flip cellular phone 300 is in the second open state and when the user's finger (the left thumb) operates the flip cellular phone 300 by way of the touch detection unit 82, the preset “positional information about a part of sensing elements situated at a position where the trace of the user's finger goes out of the guide portion G of the touch detection unit 82” corresponds to positional information about the sensing elements S2 and S6.

In the rotation detection device 80 of the present embodiment, the touch detection unit 82 has been described as being identical in configuration with the touch detection unit 32 described by reference to FIG. 4(b). However, the touch detection unit 82 is not limited to this configuration. Any one of the modification (1) of the touch detection unit 32 described by reference to FIG. 5, the modification (2) of the touch detection unit 32 described by reference to FIG. 6, and the modification (3) of the touch detection unit 32 described by reference to FIG. 7 can be applied to the touch detection unit 82.

The third embodiment has been described on the assumption that the user grips the flip cellular phone 300 with the right hand and that the user operates the touch detection unit 82 with the right thumb that grips the flip cellular phone 300. However, the finger used for operation is not limited to the right thumb. Even when the user operates the touch detection unit 82 with a left finger while gripping the flip cellular phone 300 with a right hand, the operation style determination unit 94 can determine (3) or (4), which will be described below, as a “usage state of the flip cellular phone 300” based on detection results of the plurality of sensing elements Q1 to Q16 of another other touch detection units 306 provided on the side surfaces 3038 of the lower housing 303. Namely, (3) is the first open state shown in FIG. 17(b) in which the user's finger (the left finger) operates the flip cellular phone 300 by way of the touch detection unit 82. (4) is the second open state shown in FIG. 17(c) in which the user's finger (the left finger) operates the flip cellular phone 300 by way of the touch detection unit 82.

For example, FIG. 19 shows a second example of detection performed by another touch detection unit 306. When the user's finger (the left forefinger) operates the flip cellular phone 300 in the open state by way of the touch detection unit 82, the sensing elements Q1 to Q5 of a part of another touch detection unit 306 detect touches of fingers other than the user's right thumb. The sensing elements Q9 to Q11 of a part of another touch detection unit 306 can detect a touch of a root of the user's right thumb. The sensing elements Q12 and Q13 of a part of another touch detection unit 306 detect a touch of the user's right thumb as a difference from the “usage state of the flip cellular phone 300” shown in FIG. 18.

Although the flip cellular phone 300 used in the primary open state (the first open state or the vertically open state) and the secondary open state (the second open state or the horizontally open state) has been described in connection with the third embodiment, a similar rotation detection device can also be applied to a flip cellular phone that is employed in the primary open state (the first open state or the vertically open state) and not in the secondary open state (the second open state or the horizontally open state).

Functional blocks used in the descriptions about the respective embodiments are implemented as an LSI that is a typical integrated circuit. The functional units can also be individually packaged into a single chip. Alternatively, a part or all of the functional blocks can also be packaged into a single chip. Although the LSI is herein referred to as an integrated circuit, the integrated circuit is sometimes called an IC, a system LSI, a super LSI, and a ultra-LSI according to a degree of integration.

The technique for implementing an integrated circuit is not limited to an LSI. The functional units can also be integrated in the form of a custom-designed circuit or a general-purpose processor. There may also be employed an FPGA (Field Programmable Gate Array) that is programmable after fabrication of an LSI or a reconfigurable processor that enables reconfiguration of connections or settings of a circuit cells in the LSI can also be utilized.

If a technique for implementing an integrated circuit that is replaceable with an LSI has come as a result of advancement of the semiconductor technique or another technique derived from the semiconductor technique, functional units can also be integrated by use of the technique. Application of the biotechnology, or the like, is potentially feasible.

Although the present invention has been described in detail and by reference to specific embodiments, it is apparent to those skilled in the art that various changes or modifications may be made without departing the spirit and scope of the present invention.

The present patent application is based on Japanese Patent Application (Application No. 2009-228280) filed on Sep. 30, 2009, the entire subject matter of which is incorporated herein by reference.

### INDUSTRIAL APPLICABILITY

The rotation detection device of the present invention and the mobile terminal equipped with the same provides advantages in which the rotation detection device is small-sized, and the rotation detection device can be controlled by rotation operation of a user's finger on the device such that the user's finger does not get out of the sensing range of the sensing elements, and are useful as a cellular phone, or the like.

### DESCRIPTION OF REFERENCE SIGNS

30, 60, 80: ROTATION DETECTION DEVICE

32, 62, 82: TOUCH DETECTION UNIT

34, 64, 84: TOUCH LEVEL COLLECTION UNIT

36, 66, 86: TOUCH POSITION DETERMINATION UNIT

42, 72, 92: TOUCH CHANGE MANAGEMENT UNIT

38, 68, 88: ITEM SHIFT DETERMINATION UNIT

70, 90: PERIODIC MEASUREMENT CONTROL UNIT

74, 94: OPERATION STYLE DETERMINATION UNIT

100: SLIDER CELLULAR PHONE

101: UPPER HOUSING

102: LOWER HOUSING

104: OPERATION KEY

300: FLIP CELLULAR PHONE

302: UPPER HOUSING

303: LOWER HOUSING

304: CONNECTION PORTION

314: OPERATION KEY

G: GUIDE PORTION

Sk, Qk: SENSING ELEMENT

1. A rotation detection device comprising:
a guide portion configured to guide a touch position of a finger;
one or more sensing elements configured to detect a touch of a finger; and
a determination unit configured to determine rotational operation of the finger based on a detection result of the one or more sensing elements,
wherein at least a part of the one or more sensing elements is situated closer to an outside of the rotation detection device than the guide portion.

2. The rotation detection device according to claim 1,
wherein the one or more sensing elements comprise a plurality of sensing elements having different sizes.

3. The rotation detection device according to claim 1,
wherein the one or more sensing elements comprise a first group of sensing elements arranged along an outer shape of the guide portion and a second group of sensing elements arranged closer to the outside of the rotation detection device than the guide portion.

4. The rotation detection device according to claim 3,
wherein, in addition to determining the rotational operation of the finger, the determination unit determines whether the finger belongs to a left hand or a right hand, based on the detection result of the one or more sensing elements.

5. The rotation detection device according to claim 1,
wherein the one or more sensing elements are arranged such that a sensing range of the one or more sensing elements includes a trace defined by the rotational operation of the finger.

6. The rotation detection device according to claim 1,
wherein at least a part of the one or more sensing elements is configured to move to a position closer to the outside of the rotating detection device than the guide portion.

7. A mobile terminal comprising the rotation detection device according to claim 1.
